(19) United States
(12) Patent Application Publication
(10) Pub. No.: US 2012/0242855 A1
(43) Pub. Date: Sep. 27, 2012

(54) DEVICE AND METHOD INCLUDING FUNCTION FOR RECONSTITUTING AN IMAGE, AND STORAGE MEDIUM

(75) Inventors: Tomoaki NAGASAKA, Tokyo (JP); Kouichi Nakagome, Tokyo (JP)

(73) Assignee: CASIO COMPUTER CO., LTD., Tokyo (JP)

(21) Appl. No.: 13/426,224

(22) Filed: Mar. 21, 2012

(30) Foreign Application Priority Data
Mar. 24, 2011 (JP) 2011-066698

(51) Int. Cl. H04N 5/228

(52) U.S. Cl. 348/222.1; 348/E05.031

(57) ABSTRACT

Noise that occurs when a reconstituted image is generated from a light field image captured by a plenoptic camera is reduced. A light field image acquisition section 71 acquires data of a light field image formed of an aggregation of plural sub-images respectively generated by plural microlenses 32-i, which data is obtained as a result of imaging by an imaging device 1. An interpolated light field image generation section 75 generates data of one or more interpolated light field images formed of aggregations of plural imaginary sub-images. A reconstituted image generation section 76 uses the data of the light field image and the data of the one or more interpolated light field images to generate data of a reconstituted image.

This application claims priority under 35 USC 119 from Japanese Patent Application No. 2011-066698, filed Mar. 24, 2011, the disclosure of which is incorporated by reference herein.

### BACKGROUND OF THE INVENTION

1. Field of the Invention

The present invention relates to a technology for reconstituting an image.

2. Related Art

In recent years, imaging devices that acquire information about the directional distribution of incident light rays, that is, the imaging devices known as plenoptic cameras, have been a subject of research and development.

In the optical system of a plenoptic camera, a compound lens array (hereinafter referred to as a microlens array), in which very small lenses (hereinafter referred to as microlenses) are arrayed horizontally and vertically in a continuously repeating pattern, is interposed between a related art imaging lens (hereinafter referred to as a main lens) and imaging element.

The individual microlenses constituting the microlens array distribute light focused by the main lens to plural numbers of pixels in the imaging element in accordance with angles at which the light arrives.

Thus, given that images that are respectively focused on the imaging element by the individual microlenses are referred to as sub-images, data of an image formed of an aggregation of the plural sub-images is outputted from the imaging element as captured image data.

This captured image from the plenoptic camera, that is, the image formed of the aggregation of plural sub-images, is hereinafter referred to as a light field image.

The light field image is generated by light that is incident through both the related art main lens and the microlens array. Therefore, the light field image includes, as well as the usual two-dimensional spatial information included in a conventional captured image, information that would not be included in a conventional captured image, which is two-dimensional directional information representing which directions light rays arrive from as viewed from the imaging element.

Hence, after a light field image has been captured, the plenoptic camera may use the light field image data to reconstitute an image of a plane that was an arbitrary distance forward at the time of imaging, using this two-dimensional directional information.

That is, after imaging, the plenoptic camera may use the light field image data to arbitrarily produce data of an image as if the imaging was performed with the focus at a predetermined distance (hereinafter, this is referred to as a reconstituted image), even if the focusing point was not at this predetermined distance when the light field image was captured.

More specifically, the plenoptic camera specifies a point in a plane at an arbitrary distance as being a point of interest, and calculates to which pixels in the imaging element light from the point of interest is distributed through the main lens and the microlens array.

For example, assuming the pixels of the imaging element correspond with pixels constituting the light field image, the plenoptic camera integrates pixel values of, from the pixels constituting the light field image, one or more pixels to which light from the point of interest is distributed. The integral value is the pixel value for a pixel corresponding to the point of interest in the reconstituted image. Thus, the pixel corresponding to the point of interest in the reconstituted image is reconstituted.

The plenoptic camera successively specifies respective points of interest for pixels constituting the reconstituted image (pixels corresponding to points in the plane at the arbitrary distance), and repeats the above-described sequence of processing. Thus, the plenoptic camera reconstitutes data of the reconstituted image (an aggregation of the pixel values of the pixels of the reconstituted image).

### SUMMARY OF THE INVENTION

An image processing device relating to a first aspect of the present invention includes:

an image acquisition unit that acquires a light field image formed of sub-images generated by respective microlenses, the light field image having been imaged by an imaging device in which an optical system is provided with a main lens, a microlens array formed of the microlenses, and an imaging element;

a sub-image generation unit that generates an imaginary sub-image that is interpolated on the basis of the sub-images included in the light field image; and

a reconstituted image generation unit that, using the sub-images included in the light field image acquired by the image acquisition unit and the imaginary sub-image generated by the sub-image generation unit, generates an image of a plane at a predetermined position from the imaging device to serve as a reconstituted image.

An image processing method relating to a second aspect of the present invention is

an image processing method executed by an image processing device on a light field image that has been imaged by an imaging device in which an optical system is provided with a main lens, a microlens array formed of microlenses, and an imaging element, the light field image being formed of sub-images generated by the respective microlenses, and the method including:

acquiring the light field image;

generating an imaginary sub-image that is interpolated on the basis of the sub-images included in the light field image; and

generating, using the sub-images included in the light field image and the imaginary sub-image, an image of a plane at a predetermined position from the imaging device to serve as a reconstituted image.

A computer readable storage medium relating to a third aspect of the present invention is

a non-transitory computer readable storage medium having stored therein a program executable by a computer that controls an imaging device in which an optical system is provided with a main lens, a microlens array formed of microlenses, and an imaging element, the program causing the computer to realize functions including:

acquiring a light field image imaged by the imaging device, the light field image being formed of sub-images generated by the respective microlenses;

generating an imaginary sub-image that is interpolated on the basis of the sub-images included in the light field image; and

generating, using the sub-images included in the light field image and the imaginary sub-image, an image of a plane at a predetermined position from the imaging device to serve as a reconstituted image.

### BRIEF DESCRIPTION OF THE DRAWINGS

For a better understanding of the present invention, the detailed descriptions that follow should be read in association with the following drawings.

FIG. 1 is a diagram illustrating hardware structures of an imaging device that is an embodiment of an image processing device relating to the present invention;

FIG. 2 is a diagram illustrating a structural example of an optical system included in the imaging device;

FIG. 3A is a diagram comparing a reconstituted image obtained by the imaging device with a reconstituted image obtained when a related art technology is employed;

FIG. 3B is a magnified diagram of a portion of a light field image;

FIG. 3C is a diagram illustrating three interpolated light field images;

FIG. 4 is a diagram illustrating functional structures of the imaging device;

FIG. 5 is a flowchart for describing reconstituted image generation processing;

FIG. 6A and FIG. 6B are diagrams describing a method of calculating parallax;

FIG. 7A and FIG. 7B are diagrams describing a method of generating an interpolated light field image;

FIG. 8 is a diagram for describing a method of generating an interpolated sub-image; and

FIG. 9 is a flowchart for describing reconstituted image generation processing.

### DETAILED DESCRIPTION OF THE INVENTION

Herebelow, an embodiment of the present invention is described using the attached drawings.

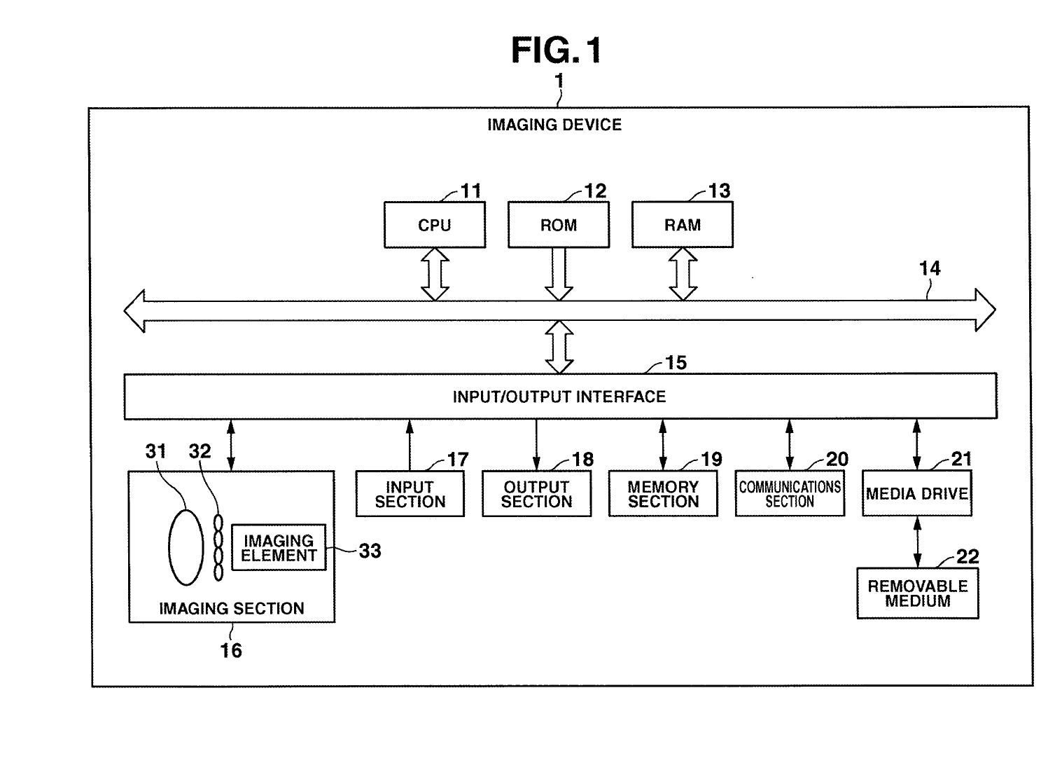

FIG. 1 is a block diagram illustrating hardware structures of an imaging device that is an embodiment of an image processing device relating to the present invention.

An imaging device 1 is equipped with a central processing unit (CPU) 11, a read-only memory (ROM) 12, a random access memory (RAM) 13, a bus 14, an input/output interface 15, an imaging section 16, an input section 17, an output section 18, a memory section 19, a communications section 20 and a media drive 21.

The CPU 11 executes various processes in accordance with a program stored in the ROM 12 or a program loaded into the RAM 13 from the memory section 19.

Data and suchlike that is required for execution of the various processes by the CPU 11 is memorized in the RAM 13 as appropriate.

The CPU 11, the ROM 12 and the RAM 13 are connected to one another via the bus 14. The input/output interface 15 is also connected to the bus 14. The imaging section 16, the input section 17, the output section 18, the memory section 19, the communications section 20 and the media drive 21 are connected to the input/output interface 15.

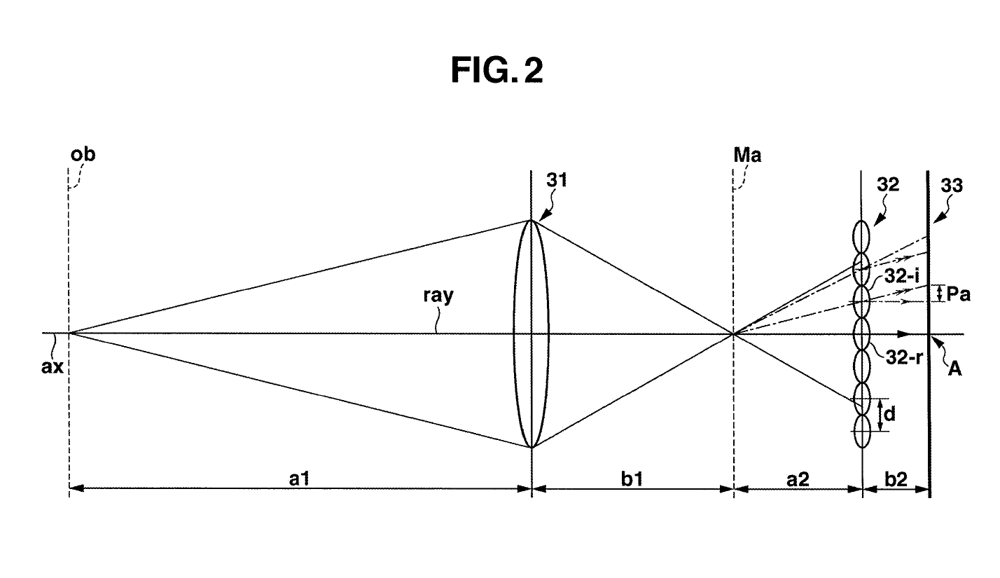

The imaging section 16 is equipped with a main lens 31, a microlens array 32 and an imaging element 33. The imaging section 16 is described in further detail below with reference to FIG. 2.

The input section 17 is constituted with various buttons such as a shutter button and the like, and inputs various kinds of information in accordance with instruction operations from a user.

The output section 18 is constituted with a display monitor and a speaker or the like, and outputs various images and voice messages.

The memory section 19 is constituted with a hard disc, a dynamic random access memory (DRAM) or the like, and memorizes various kinds of image data such as light field images, reconstituted images and the like, which are described below.

The communications section 20 controls communications with other devices (not shown) over networks, including the Internet.

A removable medium 22, such as a magnetic disc, an optical disc, a magneto-optical disc, a semiconductor memory or the like, is loaded at the media drive 21 as appropriate. A program that is read from the removable medium 22 by the media drive 21 is installed in the memory section 19 as required. Similarly to the memory section 19, the removable medium 22 may also memorize various kinds of data such as image data or the like that is memorized in the memory section 19.

FIG. 2 is a schematic diagram illustrating a structural example of an optical system in the imaging device that includes the structures of FIG. 1.

In the optical system of the imaging device 1, the main lens 31, the microlens array 32 and the imaging element 33 are arranged in this order as viewed from an object surface ob that is a subject of photographing.

In the microlens array 32, N microlenses 32-1 to 32-N (N being an arbitrary integer that is at least 2) are regularly joined in a repeating arrangement.

The main lens 31 condenses light flux emitted from light sources, focuses the light flux on a predetermined plane Ma, and causes the light flux to be incident on the microlens array 32. Hereinafter, the plane Ma focused on by the main lens 31 is referred to as the main lens focusing plane Ma.

A microlens 32-i (i being an integer in the range from 1 to N) in the microlens array 32 condenses light flux that is incident through the main lens 31 from the object surface ob in respective incidence directions of the light flux, thus focusing a sub-image onto the imaging element 33.

That is, at the imaging element 33, a plural number of sub-images are respectively focused by the plural number of microlenses 32-1 to 32-N, and a light field image that is an aggregation of the plural sub-images is generated.

The imaging element 33 is structured by, for example, a complementary metal oxide semiconductor (CMOS) optoelectronic conversion device or the like. A subject image (in the example in FIG. 2, an image of the object surface ob) is incident on the imaging element 33 via the main lens 31 and the microlens array 32. Accordingly, the imaging element 33 optoelectronically converts (images) the subject image and accumulates image signals over a certain duration, and serially supplies the accumulated image signals to an unillustrated analog front end (AFE) as analog signals.

The AFE applies various kinds of signal processing such as analog-to-digital (A/D) conversion processing and the like to the analog image signals. Digital signals are generated by this signal processing and are supplied from the AFE to the CPU 11 (see FIG. 1) or the like as appropriate to serve as light field image data.

Next, generation of reconstituted image data by the imaging device 1 from light field image data obtained as a result of imaging an object surface ob is considered.

For this generation, the imaging device 1 specifies a point in a plane that is at an arbitrary distance as being a point of interest, and calculates to which pixels in the imaging element 33 light from the point of interest was distributed through the main lens 31 and the microlens array 32. Hereinafter, the reconstitution target plane, which is to say the plane in which the point of interest is specified, is referred to as a reconstitution plane.

Then, by integrating pixel values in the light field image data corresponding to the pixels to which light was distributed, the imaging device 1 calculates by inference the pixel value of a pixel that corresponds to the point of interest in the reconstituted image.

By carrying out this inference calculation for each of pixels in the reconstituted image, the imaging device 1 generates reconstituted image data.

However, a typical technology for this inference calculation of the pixels of the reconstituted image (hereinafter referred to as a reconstitution calculation) is executed using only the light field image data obtained by the imaging.

Consequently, if an object region with a high spatial frequency is not present at the reconstitution plane, the reconstitution calculation produces cyclical noise in a region, of regions of the reconstituted image, at which, ideally, natural blurring should occur in the same manner as in a case of imaging by an ordinary imaging device.

Accordingly, the present inventors have invented a method for generating data of an interpolated light field image from the light field image data that is obtained by imaging, in order to reduce this noise. Hereinafter, this method is referred to as the interpolated light field image generation method.

Herebelow, this interpolated light field image generation method is described, including what kind of data the interpolated light field image data is, and how the generated interpolated light field image data is used to reduce noise.

Herebelow, unless otherwise stated, where a simple “distance” is referred to, the meaning thereof is a distance in a direction parallel to an optical axis ax. Furthermore, a point of the lens through which the optical axis ax passes is referred to as the principal point.

When the positions of the main lens 31, the microlens array 32 (the individual microlenses 32-i) and the imaging element 33 are fixed, which pixels in the imaging element 33 light rays reach is determined by what positions light sources of the rays are disposed at as viewed from the principal point of the main lens 31. Therefore, for simplicity of description herebelow, a case in which a light source is at the object surface ob and disposed on the optical axis ax of the main lens 31 is considered.

As illustrated in FIG. 2, if the principal point of the main lens 31 is disposed at a position at a distance a1 from the light source (the center of the object surface ob in the example of FIG. 2), a distance b1 from the principal point of the main lens 31 to the imaging plane Ma can be found using the Gaussian focusing equation, as in the following expression (1).

b1=a1×f1/(a1−f1) (1)

In expression (1), f1 represents the focusing distance of the main lens 31.

The distance from the imaging plane Ma of the main lens 31 to the principal point of the microlens 32-i is represented by a2. A distance from the principal point of the microlens 32-i to a position at which the light rays incident on the microlens 32-i are emitted and focused is represented by b2.

Thus, the relationship between the distance a2 and the distance b2 can be represented as in expression (2).

b2=a2×f2/(a2−f2) (2)

In expression (2), f2 represents the focusing distance of the microlens 32-i.

In FIG. 2, for simplicity of description, the imaging element 33 is disposed precisely at a position at the distance b2 from the principal point of the microlens 32-i, but this is merely an example. That is, in practice the imaging element 33 does not need to be disposed precisely at the position the distance b2 from the principal point of the microlens 32-i but may be disposed some way in front of or behind that position.

Of light rays from the light source, a light ray “ray” parallel to the optical axis ax passing through the principal point of the main lens 31 is focused on the center A of a sub-image produced by, of the microlens array 32, a microlens 32-r through which the light ray “ray” passes (r being an integer value representing the number from 1 to N that is assigned to the microlens through which the light ray “ray” passes).

In contrast, of the light rays from the light source, a light ray that reaches a microlens 32-i that is adjacent to the microlens 32-r through which the optical axis ax passes (i being an integer value other than r) is focused on a position (hereinafter referred to as the imaging position) that is separated from a central position of the sub-image produced by the microlens 32-i (from a position corresponding with the principal point of the microlens 32-i) by a certain distance.

Accordingly, in the plane to which the light ray that is incident on the microlens 32-i through the main lens 31 from the light source is emitted from the microlens 32-i and focused, which is to say, the plane at which the sub-image from the microlens 32-i is formed (the imaging plane of the imaging element 33 in the example of FIG. 2), a separation distance between the central position of the sub-image and the imaging position of the light ray through the microlens 32-i is referred to hereinafter as the parallax.

If the parallax is denoted by Pa to match FIG. 2, it can be represented as in the following expression (3).

Pa=d×(b2/a2) (3)

In expression (3), d represents the pitch between the two adjacent microlenses 32-r and 32-i.

Relationships with the parallax Pa expressed by the above expression (3) are also geometrically established between adjacent pairs of microlenses 32-k and 32-(k+1) at positions that are separated from the optical axis ax (k being some integer from 1 to N−1 other than r). Therefore, the parallax Pa is constant and not dependent on a distance from the optical axis ax.

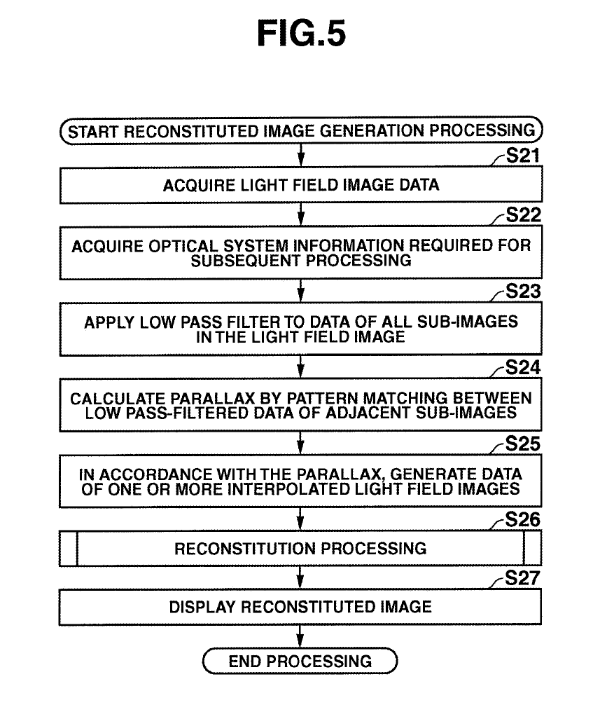

As is described in detail below with reference to FIG. 5, the parallax may be calculated from the light field image data that is actually obtained by imaging.

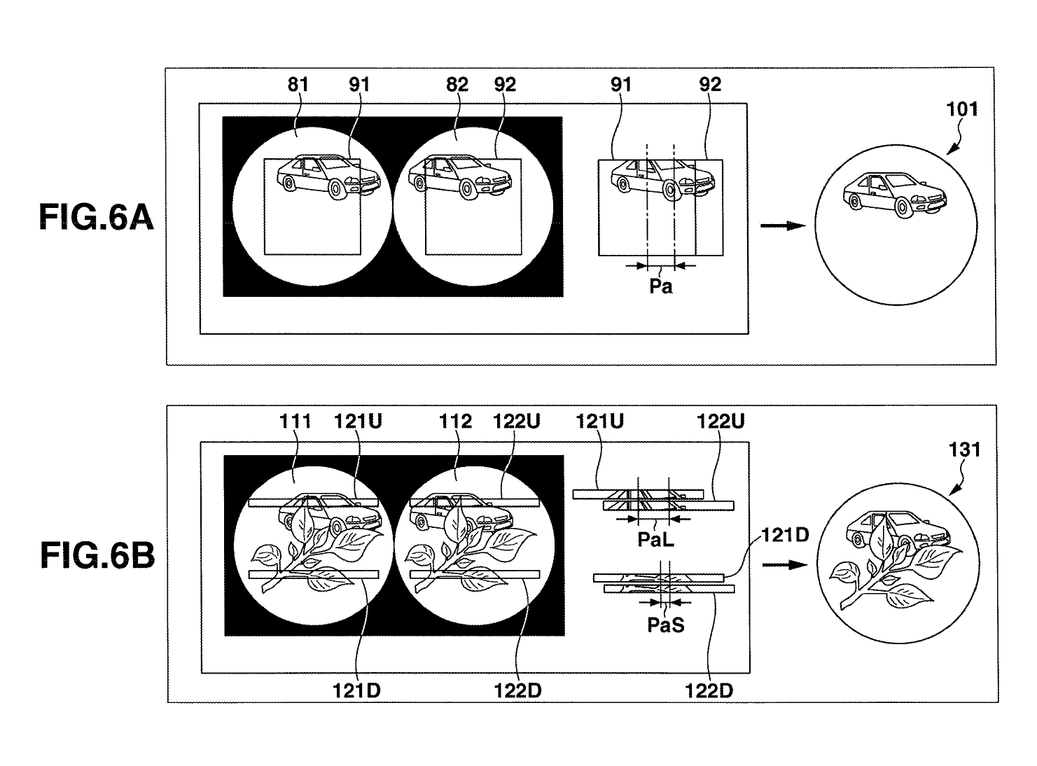

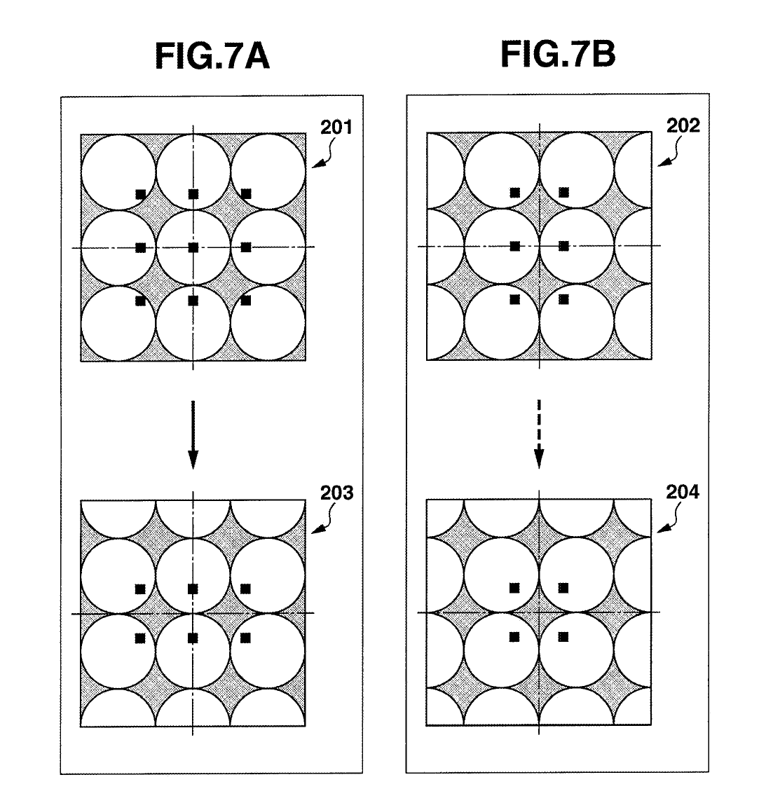

Further, as is described in detail below with reference to FIG. 6A, FIG. 6B, FIG. 7A and FIG. 7B, the interpolated light field image data may be created in accordance with the parallax Pa.

The meaning of the term “interpolated light field image” as used herein is intended to include a light field image that is inferred as an image that would be obtained if imaginary microlenses were notionally disposed at, of regions in the microlens array 32, regions at which the microlenses 32-i are not actually disposed (on lines linking between the plural microlenses 32-i and the like) and imaging was carried out under the same conditions as at the moment of imaging of a light field image that is actually obtained.

As mentioned above, as an example of an interpolated light field image generation method, a method of using light field image data actually obtained by imaging to calculate the parallax Pa and calculating estimated data of interpolated light field images on the basis of the parallax Pa may be employed. This method may be employed in the present embodiment.

Thus, the imaging device 1 of the present embodiment may generate one or more sets of interpolated light field image data with this interpolated light field image generation method. Then the imaging device 1 of the present embodiment may use the one or more sets of interpolated light field image data when performing the reconstitution calculations required for generating data of a reconstituted image.

The imaging device 1 may infer the light rays that would reach regions at which a microlens 32-i is not actually disposed from the one or more sets of interpolated light field image data. Hence, the imaging device 1 may calculate which pixels in the imaging element 33 light from points of interest would be distributed to through regions that are inferred thus.

Therefore, by using the results of these calculations as interpolation information in the inference calculations of the pixel values corresponding to points of interest, the imaging device 1 may generate reconstituted image data with lower noise than in the related art.

The degree of noise reduction varies depending on interpolation positions and the number of interpolations in the interpolated light field image. Therefore, a designer or the like may suitably adjust the interpolation positions and number of interpolations so as to achieve a desired degree of noise reduction.

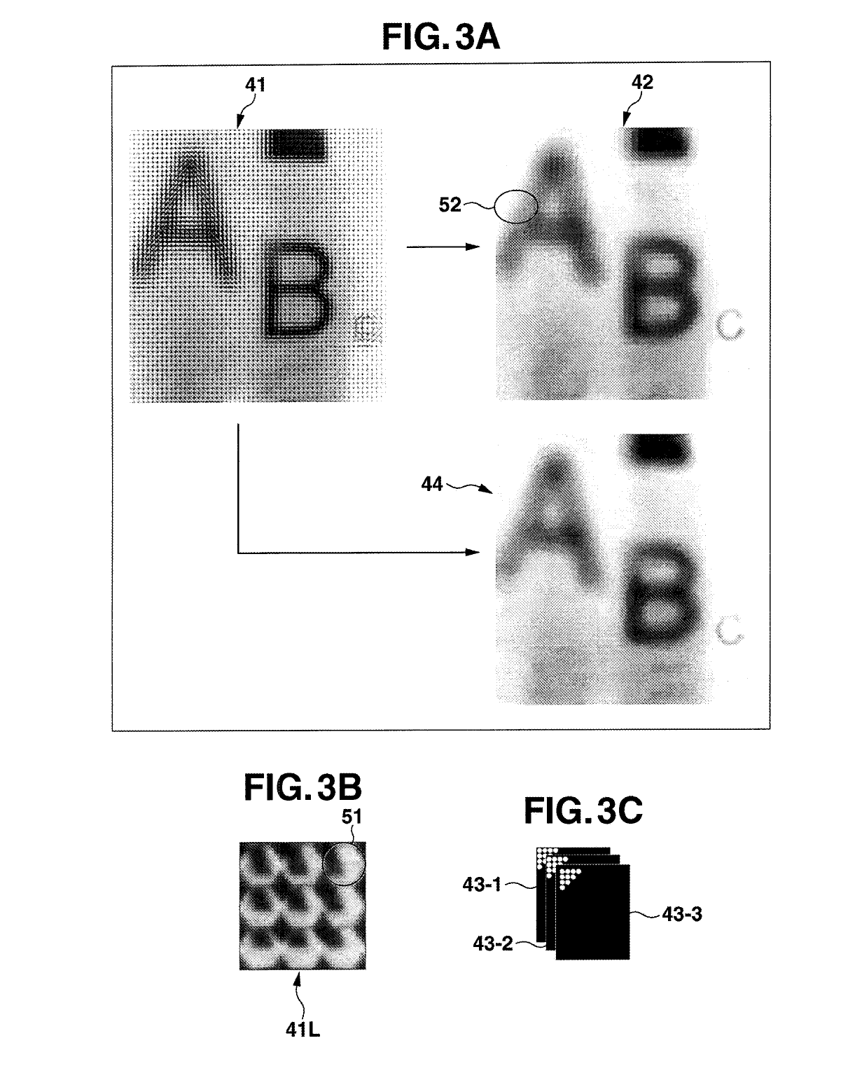

FIG. 3A is a diagram comparing a reconstituted image obtained when this interpolated light field image generation method relating to the present invention is employed with a reconstituted image obtained when a related art technology is employed.

FIG. 3A shows a light field image 41 obtained by imaging. FIG. 3B shows a portion 41L of the light field image 41 in a magnified diagram in which the portion 41L is magnified to an extent such that a sub-image 51 can be discerned.

The light field image 41 is an image imaged in a state in which, in order of closeness from in front of the main lens 31, a card marked with “A”, a card marked with “B” and a card marked with “C” are disposed at constant distance intervals. As illustrated in FIG. 3A, it can be seen that the card marked with “B” is substantially in focus at the moment of imaging of the light field image 41.

Accordingly, in this example, a reconstitution calculation is performed so as to obtain a reconstituted image such that the card marked with “C” is in focus.

FIG. 3A shows a reconstituted image 42 that is obtained if a related art technology is employed. That is, data of the reconstituted image 42 is generated as a result of performing reconstitution calculations using only the data of the light field image 41 obtained by the imaging. In the reconstituted image 42, it can be seen that cyclical noise in spatial directions is produced at a region 52 and the like.

FIG. 3A also shows a reconstituted image 44 that is obtained when the interpolated light field image generation method relating to the present invention is employed. That is, the data of the reconstituted image 44 is generated as a result of performing the reconstitution calculations using, in addition to the data of the light field image 41 obtained by the imaging, three interpolated light field images 43-1 to 43-3 that are generated with the interpolated light field image generation method relating to the present invention, which are illustrated in FIG. 3C. In the reconstituted image 44, it can be seen that the card marked with “C” is in focus with substantially no cyclical noise in spatial directions, and the images of the other cards marked with “A” and “B” have become unfocused images (the images that they ideally should be in principle).

As mentioned above, the imaging device 1 of the present embodiment may generate data of one or more interpolated light field images from data of a captured light field image, and generate reconstituted image data on the basis of the respective data of the captured light field image data and the one or more interpolated light field images. This sequence of processing is referred to hereinafter as reconstituted image generation processing.

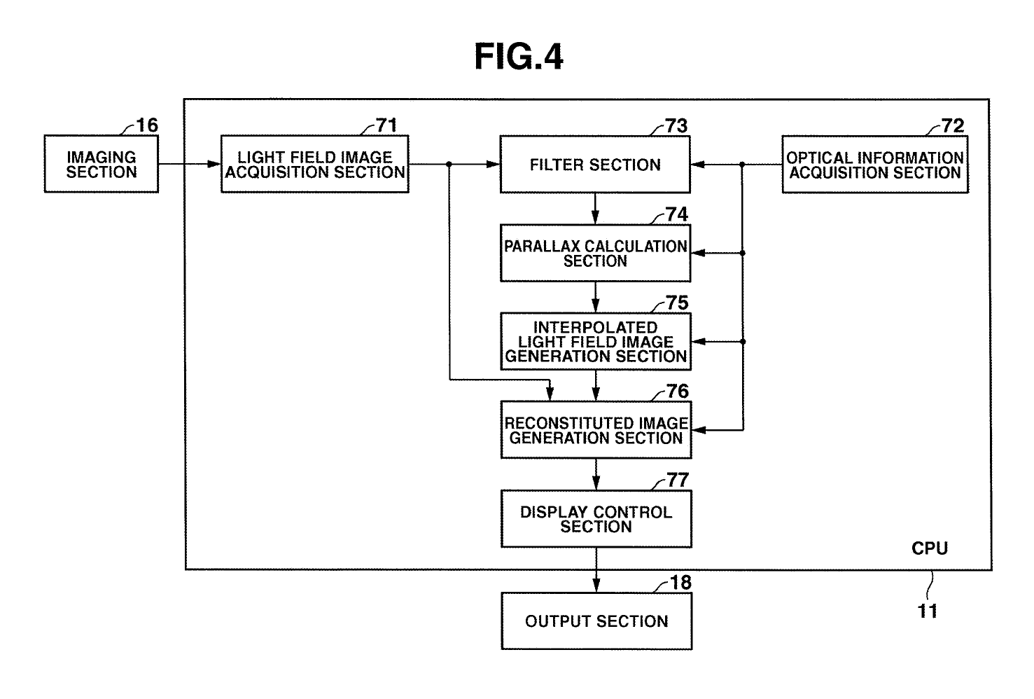

FIG. 4 is a functional block diagram illustrating an example of functional structure of the imaging device 1 of FIG. 1, for realizing functions for executing this reconstituted image generation processing.

When the reconstituted image generation processing is executed, as illustrated in FIG. 4, the CPU 11 functions as a light field image acquisition section 71, an optical information acquisition section 72, a filter section 73, a parallax calculation section 74, an interpolated light field image generation section 75, a reconstituted image generation section 76 and a display control section 77.

Herebelow, the respective functions of the light field image acquisition section 71 to display control section 77 are described in association with descriptions of the flow of the reconstituted image generation processing.

FIG. 5 is a flowchart describing an example of the flow of the reconstituted image generation processing that is executed by the imaging device of FIG. 1 that includes the functional structures of FIG. 4.

Assuming that data of an imaged light field image has already been obtained, the reconstituted image generation processing is started when generation of a reconstituted image is instructed by a predetermined operation of the input section 17 by a user.

In step S21, the light field image acquisition section 71 acquires the light field image data that has already been imaged.

In step S22, the optical information acquisition section 72 acquires optical system information that is required for subsequent processing (the processing from step S23 onward.

The meaning of the term “optical system information” as used herein includes information from the moment at which the light field image was imaged, which is various kinds of information relating to each of the main lens 31, the microlenses 32-i and the imaging element 33, information representing positional relationships thereof and suchlike.

Specifically, in the present embodiment, the following types of information (A) to (J) are acquired as optical system information.

(A) The focusing distance of the main lens 31

(B) The effective diameter of the main lens 31

(C) The focusing distance of each microlens 32-i

(D) The effective diameter of each microlens 32-i

(E) The pixel size of the imaging element 33

(F) The pitch of the microlenses 32-i

(G) The positional relationship of the main lens 31 and the microlens array 32

(H) The positional relationship of the microlens array 32 and the imaging element 33

(I) Parallelism of the main lens 31 and the microlens array 32

(J) Parallelism of the microlens array 32 and the imaging element 33

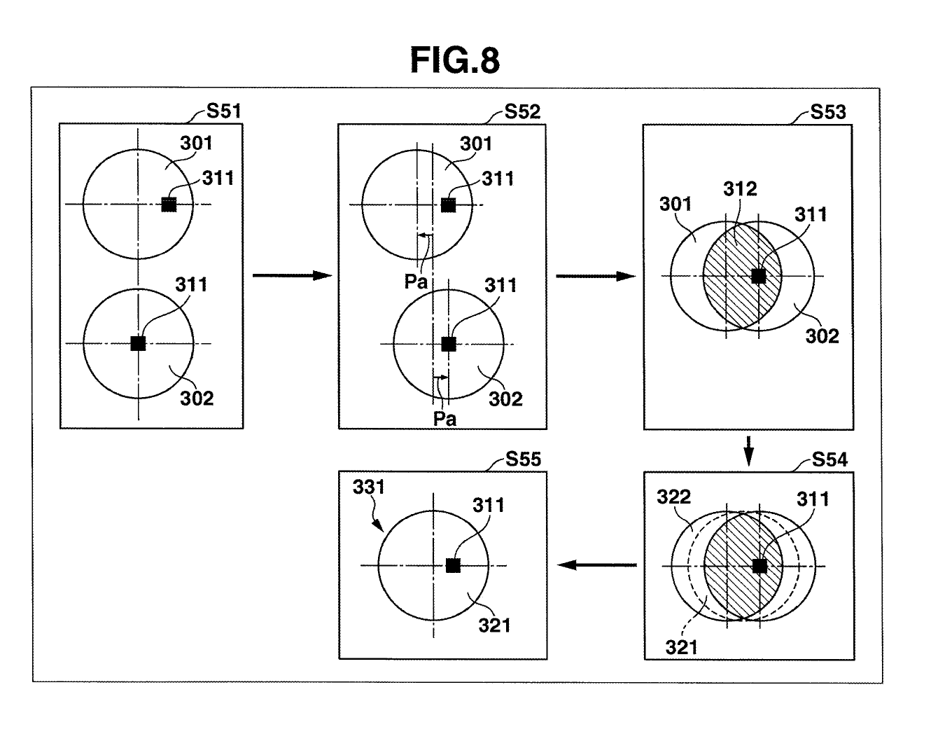

When this optical system information is acquired, in the processing from step S23 onward, sub-image regions and non-sub-image regions in the light field image may be distinguished (see FIG. 8) and the behavior of light rays inside the imaging device 1 and the like may be computed.

In step S23, the filter section 73 applies a low pass filter to the data of all sub-images in the light field image for the purpose of reducing noise contained in the imaged light field image itself.

Here, the filter section 73 executes filter processing using this low pass filter such that pixels outside the sub-image regions are not included in the window of the low pass filter. This is in order to prevent information from the non-sub-image regions being included in the sub-image region as noise. The sub-image regions and non-sub-image regions are described below with reference to FIG. 8.

In step S24, the parallax calculation section 74 calculates the parallax Pa by performing pattern matching between, of the respective sets of sub-image data to which the low pass filter has been applied in the processing of step S23, sets of data of neighboring sub-images.

Specific techniques relating to the pattern matching and the calculation of the parallax Pa are described below with reference to FIG. 6A and FIG. 6B.

In step S25, the interpolated light field image generation section 75 generates data of one or more interpolated light field images on the basis of the parallax Pa calculated by the processing of step S24.

A specific example of an interpolated light field image generation method is described below with reference to FIG. 7A, FIG. 7B and FIG. 8.

In step S26, the reconstituted image generation section 76 generates data of a reconstituted image, using the light field image data acquired by the processing of step S21 and the data of one or more interpolated light field images generated by the processing of step S25.

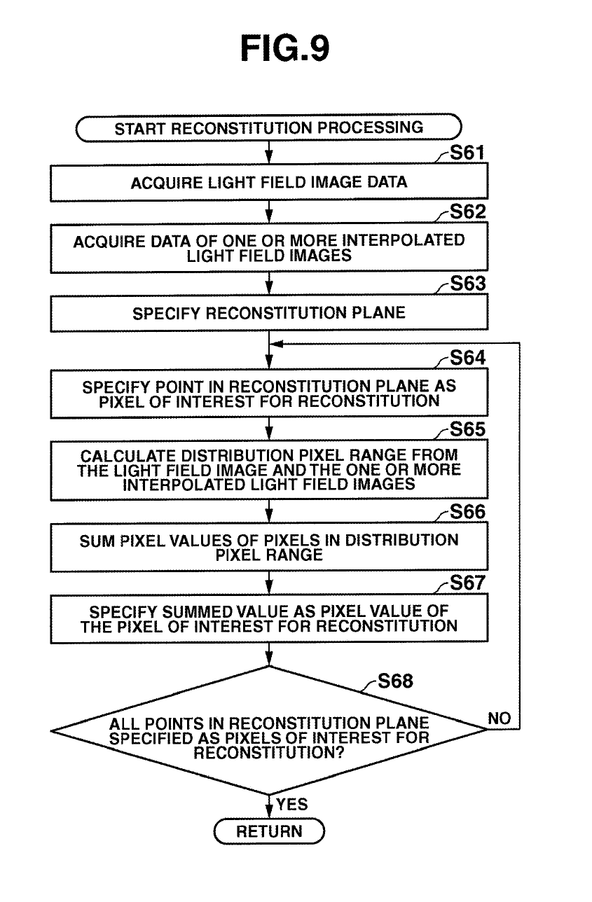

This processing is referred to hereinafter as reconstitution processing. Details of the reconstitution processing are described below with reference to FIG. 9.

In step S27, the display control section 77 displays the reconstituted image generated as data by the processing of step S26 at the monitor of the output section 18.

Thus, the reconstituted image generation processing ends.

Next, an example of the method of calculating the parallax Pa that is employed in step S24 of this reconstituted image generation processing is described with reference to FIG. 6A and FIG. 6B.

FIG. 6A and FIG. 6B are diagrams describing the example of the parallax calculation method.

More specifically, two different examples of methods of calculating parallax by pattern matching between adjacent sub-images are illustrated in FIG. 6A and FIG. 6B.

In the example in FIG. 6A, the parallax calculation section 74 performs pattern matching of adjacent sub-images 81 and 82 by calculating degrees of difference between block units, such as sums of absolute differences (SAD), sums of squared differences (SSD) or the like.

That is, the parallax calculation section 74 uses, for example, a block 91 of the left sub-image 81 as a template, and calculates degrees of difference from comparison target blocks in the sub-image 82 (a block 92 is illustrated in the drawing) by raster scanning in the right sub-image 82. More specifically, the parallax calculation section 74 calculates degrees of difference, the SAD, SSD or the like, using differences between respective pixel values at corresponding positions within the blocks of the template and the comparison target.

Then, the parallax calculation section 74 extracts a block (block 92 in the drawing) that has the smallest degree of difference from the template (block 91), and calculates a spatial position offset between the template and the extracted block as the parallax Pa.

The method illustrated in FIG. 6A is useful if, as illustrated in FIG. 6A, only objects that are at a certain depth are present in one sub-image.

In the example in FIG. 6B, the parallax calculation section 74 performs pattern matching of adjacent sub-images 111 and 112 by calculating differences between line units.

More precisely, differences are calculated not for all lines in the light field image but for a portion of the sub-image 111 and a portion of the sub-image 112. Hereinafter, for simplicity of description, a portion of a predetermined line in the sub-image 111 or 112 is referred to simply as “a line”.

For example, a line 121U of the left sub-image 111 is used as a template, and degrees of difference from comparison target lines (line 122U is illustrated in the drawing) are calculated by raster scanning in the right sub-image 112.

Then, the parallax calculation section 74 extracts a line (line 122U in the drawing) that has the smallest degree of difference from the template (line 121U), and calculates a spatial position offset between the template and the extracted line as a parallax PaL.

As is illustrated in FIG. 6B, the template is not particularly limited to being the single line 121U and may be a plural number of lines. In the present example, in addition to the above-mentioned line 121U, a line 121D is also employed as a template.

That is, the parallax calculation section 74 uses, for example, the line 121D of the left sub-image 111 as a further template and calculates degrees of difference from comparison target lines (a line 122D is illustrated in the drawing) by raster scanning in the right sub-image 112.

Then the parallax calculation section 74 extracts a line (line 122D in the drawing) that has the smallest degree of difference from the template (line 121D), and calculates a spatial position offset between the template and the extracted line as a parallax PaS.

It can be seen that the values (distances) of the parallax Pal, and the parallax PaS are different in this case. Thus, when the example of FIG. 6B is employed, parallaxes Pa that are different for each line may be used.

FIG. 7A and FIG. 7B are diagrams describing specific examples of a method for generating an interpolated light field image using this parallax Pa.

The horizontal direction in these drawings represents the horizontal direction in the light field images and is hereinafter referred to as the X direction. The vertical direction in these drawings represents the vertical direction in the light field images and is hereinafter referred to as the Y direction.

FIG. 7A illustrates a light field image 201 that has been imaged with the positional relationship in FIG. 2. The nine circles in the light field image 201 represent sub-images, and the black squares in the sub-images represent images of a light source disposed on the optical axis ax (a light source disposed at the center of the object surface ob). The sub-images and the light source images have the same forms in other images described below.

In accordance with the parallax Pa, the interpolated light field image generation section 75 interpolates imaginary sub-images along the X direction relative to the imaged light field image 201, and generates data of an X direction-interpolated light field image 202. That is, in the data of the X direction-interpolated light field image 202 that is generated, imaginary sub-images are disposed between sub-images of the light field image that are adjacent in the X direction.

In accordance with the parallax Pa, the interpolated light field image generation section 75 also interpolates imaginary sub-images along the Y direction relative to the imaged light field image 201 and generates data of a Y direction-interpolated light field image 203. That is, in the data of the Y direction-interpolated light field image 203 that is generated, imaginary sub-images are disposed between sub-images of the light field image that are adjacent in the Y direction.

Then, the interpolated light field image generation section 75 uses the data of one or both of the X direction-interpolated light field image 202 and the Y direction-interpolated light field image 203 to generate data of an X-Y direction-interpolated light field image 204 in which imaginary sub-images are interpolated to positions in X-Y directions (45° diagonal directions) relative to the imaged light field image 201. That is, in the data of the X-Y direction-interpolated light field image 204 that is generated, imaginary sub-images are disposed between sub-images in the light field image that are adjacent in the X-Y directions.

In the example in FIG. 7A and FIG. 7B, the positions of the interpolated imaginary sub-images are at central positions between the sub-images that are adjacent in the X direction, the Y direction and the X-Y directions, but this is not particularly a limitation. Interpolated sub-images may be at arbitrary positions in arbitrary directions. Furthermore, in the example in FIG. 7A and FIG. 7B, the number of interpolated light field images is set to one in each direction, but this is not particularly a limitation. There may be arbitrary numbers of interpolated light field images for the respective directions.

Next, an example of a method of generating the imaginary sub-images in these interpolated light field images (hereinafter referred to as interpolated sub-images) is described with reference to FIG. 8.

FIG. 8 is a diagram for describing the example of the method of generating interpolated sub-images.

Specifically, FIG. 8 illustrates an example of a procedure when a predetermined position between sub-images 301 and 302 that are adjacent in the X direction is set as an interpolation position and data of a single interpolated sub-image at this interpolation position is generated.

The black square image 311 represents an image of the light source disposed on the optical axis ax illustrated in FIG. 2 (the light source disposed at the center of the object surface ob).

First, in step S51, the interpolated light field image generation section 75 matches up central positions of the data of the adjacent sub-images 301 and 302.

Next, in step S52, the interpolated light field image generation section 75 moves the data of the sub-images 301 and 302 by distances corresponding to the calculated parallax Pa.

The movement directions of the two sub-images 301 and 302 at this time are respectively opposite and the movement amounts differ depending on the interpolation position. However, the total of the movement amounts of the sub-images 301 and 302 is equal to the parallax Pa.

That is, as illustrated in FIG. 8, the data of the sub-images 301 and 302 are moved such that the positions of the black square image 311 coincide.

Then, in step S53, the interpolated light field image generation section 75 combines the data of the two sub-images 301 and 302 that have been moved.

In this case, the interpolated light field image generation section 75 employs averages of the respective pixel values of the sub-images 301 and 302 for a region 312 in which the two sub-images 301 and 302 overlap, and simply employs the original pixel values of the sub-images 301 and 302 for non-overlapping regions.

Next, in step S54, the interpolated light field image generation section 75 identifies a sub-image region, which is a region 321 in the regions combined by the processing of step S53 that has the same shape as the sub-images and is formed with the interpolation position at the center thereof (i.e., the dotted line region 321 in FIG. 8), and identifies a region 322 outside the region 321 as a non-sub-image region.

That is, the interpolated light field image generation section 75 divides the combined region into the sub-image region 321 and the non-sub-image region 322

Then, in step S55, the interpolated light field image generation section 75 erases the data of the non-sub-image region 322 (retaining the data of the sub-image region 321), and thus generates data of an interpolated sub-image 331.

In the example of FIG. 8, the interpolated sub-image 331 that is ultimately obtained is a full circle. However, depending on the ratio of the movement amounts of the two sub-images 301 and 302, it may not be a full circle and may be partially indented.

In such a case, the interpolated light field image generation section 75 may make up the data of the interpolated sub-image 331 to data of a full circle by assigning pixel values to the indented regions.

A method of assigning pixel values to an indented region is not particularly limited. A method of interpolating pixel values of nearby pixels, a method of registering the indented region as a region that should not be referred to during the reconstitution, or the like may be employed.

Now, processing that generates the reconstituted image data using the data of the one or more interpolated light field images that have been generated thus, that is, the reconstitution processing in step S26 of FIG. 5, is described in detail.

FIG. 9 is a flowchart for describing detailed flow of the reconstitution processing of step S26 in FIG. 5.

In step S61, the reconstituted image generation section 76 of the CPU 11 acquires the data of the light field image.

In step S62, the reconstituted image generation section 76 acquires the data of the one or more interpolated light field images.

In step S63, the reconstituted image generation section 76 specifies a plane at a position a predetermined distance forward from the main lens 31 of the imaging device 1 as a reconstitution plane.

In step S64, the reconstituted image generation section 76 specifies a point in the reconstitution plane as a pixel of interest for reconstitution.

In step S65, the reconstituted image generation section 76 calculates a distribution pixel range from the light field image and the one or more interpolated light field images.

The meaning of the term “distribution pixel range” as used herein includes a range of pixels within the imaging element 33 to which light from the pixel of interest for reconstitution is distributed through the main lens 31 and the microlens array 32. In the related art, this is a range of pixels in a light field image.

In the present embodiment, by contrast, the distribution pixel range is calculated from ranges of pixels including the one or more interpolated light field images as well as the light field image. Therefore, compared with a related art display of a reconstituted image that is generated using a distributed pixel range selected only from the light field image, cyclical noise in spatial directions is reduced.

In step S66, the reconstituted image generation section 76 integrates the pixel values of the respective pixels in the distributed pixel range.

In step S67, the reconstituted image generation section 76 specifies the integrated value obtained as the result of the processing of step S66 as being the pixel value of the pixel of interest for reconstitution.

In step S68, the reconstituted image generation section 76 determines whether or not all points of the reconstitution plane have been specified as pixels of interest for reconstitution.

If there is a point among the points of the reconstitution plane that has not yet been specified as the pixel of interest for reconstitution, the result of the determination of step S68 is negative (“NO”), the processing returns to step S64, and the subsequent processing is repeated. That is, the respective points of the reconstitution plane are sequentially specified as pixels of interest for reconstitution, the loop of processing from step S64 to step S68 is repeatedly executed, and pixel values of the pixels of interest for reconstitution are specified.

Thus, the reconstituted image data is generated by specifying the respective pixel values of the points in the reconstitution plane. Hence, the result of the determination of step S68 in FIG. 9 is positive (“YES”), and the processing advances to step S27. In step S27, the CPU 11 outputs the display of the reconstituted image through the output section 18.

As described above, the imaging device 1 relating to the present embodiment includes the optical system that includes the main lens 31, the microlens array 32 constituted by the plural microlenses 32-i, and the imaging element 33. The imaging device 1 is also provided with the light field image acquisition section 71, the interpolated light field image generation section 75 and the reconstituted image generation section 76.

The light field image acquisition section 71 acquires the data of a light field image from an aggregation of plural sub-images respectively generated by the plural microlenses 32-i, which are obtained as a result of imaging by the imaging device 1.

The interpolated light field image generation section 75 generates data of one or more interpolated light field images formed of aggregations of plural imaginary sub-images.

The reconstituted image generation section 76 uses the data of the light field image and the data of the one or more interpolated light field images to generate data of a reconstituted image.

When a reconstituted image that is generated as data in this manner is displayed, noise that is cyclical in spatial directions is reduced in comparison with a case in which, as in the related art, a reconstituted image that is generated only from the data of a light field image is displayed.

The present invention is not limited to the embodiment described above; modifications, improvements and the like within a scope capable of achieving the object of the present invention are to be encompassed by the present invention.

For example, when a reconstituted image is being generated in the embodiment described above, data of a light field image and data of interpolated light field images are used. However, this is not a particular limitation.

That is, the aforementioned noise reduction effect may be achieved by increasing the number of sub-images used in reconstitution calculations. Therefore, it is sufficient that imaginary sub-images be present; data of interpolated light field images is not particularly required for an embodiment.

In other words, it is sufficient that the reconstituted image generation section 76 be capable of generating reconstituted image data by using one or more imaginary sub-images in addition to the plural sub-images included in the light field image.

As a further example, in the embodiment described above, for the data of the light field image that is used when generating data of the reconstituted image, a light field image captured by the imaging device 1 itself is employed, but this is not a particular limitation.

That is, the imaging device 1 may generate data of a reconstituted image using light field image data captured by a separate imaging device 1 or by a separate, conventional plenoptic camera.

That is to say, beside the imaging device 1 with the imaging function, the present invention may be applied to general electronic equipment that has usual image processing functions but does not have imaging functions. For example, the present invention may be applied to personal computers, printers, television sets, video cameras, navigation devices, portable telephones, portable videogame machines and so forth.

The above-described sequence of processing may be executed by hardware and may be executed by software.

That is, the functional structure in FIG. 4 is merely an example and is not particularly limiting. In other words, it is sufficient that the imaging device 1 be provided with functions capable of executing the above-described sequence of processing as a whole; the kinds of functional blocks used for executing the functions are not particularly limited by the example in FIG. 4.

Moreover, the individual functional blocks may be constituted by hardware units, may be constituted by software units, and may be constituted by combinations thereof.

If a sequence of processing is to be executed by software, a program constituting the software is installed at a computer or the like from a network or a recordable medium or the like.

This computer may be a computer incorporating special-purpose hardware. The computer may also be a computer capable of executing different kinds of functions in accordance with the installation of different programs, for example, a general-purpose personal computer.

As well as the removable medium 22 in FIG. 1 that is distributed separately from the main body of the equipment for supplying the program to users, a recording medium containing such a program may be constituted by a recording medium that is supplied to users in a state of being incorporated in the main body of the equipment. The removable medium 22 is constituted by, for example, a magnetic disc (including floppy disks), an optical disc, a magneto-optical disc or the like. An optical disc is, for example, a CD-ROM (Compact Disc Read-Only Memory), a DVD (Digital Versatile Disc) or the like. A magneto-optical disc is, for example, a MiniDisc (MD) or the like. A recording medium that is supplied to users in a state of being incorporated in the main body of the equipment is constituted by, for example, the ROM 12 of FIG. 1, in which the program is stored, a hard disc included in the memory section 19 of FIG. 1, or the like.

Obviously, processing in which the steps describing the program stored in the recording medium are carried out chronologically in the described order is encompassed by the present specification. Processing that is not necessarily carried out chronologically but in which the steps are executed in parallel or separately is also to be encompassed.

A number of embodiments of the present invention are explained hereabove. These embodiments are merely examples and do not limit the technical scope of the invention. The present invention may be attained by numerous other embodiments, and numerous modifications such as omissions, substitutions and the like are possible within a technical scope not departing from the spirit of the invention. These embodiments and modifications are to be encompassed by the scope and gist of the invention recited in the present specification and the like, and are encompassed by the inventions recited in the attached claims and their equivalents.

What is claimed is:

1. An image processing device comprising:
an image acquisition unit that acquires a light field image formed of sub-images generated by respective microlenses, the light field image having been imaged by an imaging device in which an optical system is provided with a main lens, a microlens array formed of the microlenses, and an imaging element;
a sub-image generation unit that generates an imaginary sub-image that is interpolated on the basis of the sub-images included in the light field image; and
a reconstituted image generation unit that, using the sub-images included in the light field image acquired by the image acquisition unit and the imaginary sub-image generated by the sub-image generation unit, generates an image of a plane at a predetermined position from the imaging device to serve as a reconstituted image.

2. The image processing device according to claim 1, further comprising: an interpolated light field image generation unit that generates an interpolated light field image formed of a plurality of the imaginary sub-image generated by the sub-image generation unit,
wherein the reconstituted image generation unit generates the reconstituted image using, in addition to the light field image, the interpolated light field image generated by the interpolated light field image generation unit.

3. The image processing device according to claim 2, wherein the interpolated light field image generation unit generates the interpolated light field image such that the imaginary sub-images are disposed between adjacent sub-images of the light field image.

4. The image processing device according to claim 3, further comprising a parallax calculation unit that calculates a difference between, in the adjacent sub-images of the light field image, distances between focusing positions by the microlenses and central positions to serve as a parallax,
wherein the interpolated light field image generation unit generates the interpolated light field image such that the imaginary sub-images are disposed in accordance with parallaxes calculated by the parallax calculation unit.

5. The image processing device according to claim 4, wherein the parallax calculation unit performs pattern matching at respective regions of a predetermined unit in the adjacent sub-images of the light field image, and calculates the parallax using a result of the pattern matching.

6. The image processing device according to claim 5, wherein each region of the predetermined unit is a block formed by a portion of pixels constituting the sub-image df the light field image.

7. The image processing device according to claim 5, wherein each region of the predetermined unit is a block formed by a portion of pixels constituting the sub-image at a predetermined line of the light field image.

8. An image processing method executed by an image processing device on a light field image that has been imaged by an imaging device in which an optical system is provided with a main lens, a microlens array formed of microlenses, and an imaging element, the light field image being formed of sub-images generated by the respective microlenses, and the method comprising:
acquiring the light field image;
generating an imaginary sub-image that is interpolated on the basis of the sub-images included in the light field image; and
generating, using the sub-images included in the light field image and the imaginary sub-image, an image of a plane at a predetermined position from the imaging device to serve as a reconstituted image.

9. A non-transitory computer readable storage medium having stored therein a program executable by a computer that controls an imaging device in which an optical system is provided with a main lens, a microlens array formed of microlenses, and an imaging element, the program causing the computer to realize functions of:
acquiring a light field image imaged by the imaging device, the light field image being formed of sub-images generated by the respective microlenses;
generating an imaginary sub-image that is interpolated on the basis of the sub-images included in the light field image; and
generating, using the sub-images included in the light field image and the imaginary sub-image, an image of a plane at a predetermined position from the imaging device to serve as a reconstituted image.
